(19) United States
(12) Patent Application Publication
(10) Pub. No.: US 2006/0152872 A1
(43) Pub. Date: Jul. 13, 2006

(54) Automatic DC power detection device containing circuit protection device for over-voltage and over-current protection

(76) Inventor: Tsun Huang Lin, Taipei Hsien (TW)

Correspondence Address: Tsun Huang Lin, 235 Chung-Ho, Box 8-24, Taipei, TW

(21) Appl. No.: 11/032,619

(22) Filed: Jan. 11, 2005

(51) Int. Cl. H02H 3/26

(52) U.S. Cl. 361/78

(57) ABSTRACT

An automatic DC power detection device containing circuit protection device for over-voltage and over-current protection comprises a DC power detection and display device for detecting a state of a DC power source; an electronic adjustable timing loop for generating a clock; an electronic switching circuit for switching to a load or a display state with the use of the timing loop; a plurality of loads for automatically detecting the DC power source; an equivalent load matching to predetermined load conditions and a DC power source state display device; a voltage signal detecting device for processing voltage states; a current signal detecting device for processing current states; and a DC power protection device for protecting a DC power system and other related device. The DC power protection device comprises an over voltage protection device; an over current protection device; and an over load protection device.

### FIELD OF THE INVENTION

The present invention relates to DC (direct current) power detection and protection, and in particular to an automatic DC power detection device containing circuit protection device for over-voltage and over-current protection, and displaying various states so as to avoid the faults of the system.

### BACKGROUND OF THE INVENTION

DC (direct current) power sources are frequently used in industry and life. The AC (alternative current) power is converted into DC power. To prevent the overload of DC power system, it is necessary to have a detection circuit so as to adjust the system optimally. The present invention provide an automatic DC power detection device containing circuit protection device for over-voltage and over-current protection which is advantageous to the problem of over-voltage, over-current, or over-load because of forgetting to turn off a load, abnormality of generator, traffic accident, or short circuit, etc.

### SUMMARY OF THE INVENTION

Accordingly, the primary object of the present invention is to provide an automatic DC power detection device containing circuit protection device for over-voltage and over-current protection, and displaying various states so as to avoid the faults of the system.

Another object of the present invention is to provide an automatic DC power detection device containing circuit protection device for over-voltage and over-current protection, wherein a clock is set for automatically detecting the power state.

A further object of the present invention is to provide an automatic DC power detection device containing circuit protection device for over-voltage and over-current protection, wherein a reference voltage is compared with a measured voltage so that in abnormal, the working circuit is displayed or closed so as to perform an over-voltage or an over-current protection.

A yet object of the present invention is to provide an automatic DC power detection device containing circuit protection device for over-voltage and over-current protection, wherein a reference voltage is compared with a measured voltage so that in abnormality, the working circuit is displayed or closed so as to perform an over-load protection.

An automatic DC power detection device containing circuit protection device for over-voltage and over-current protection comprises a DC power detection and display device for detecting a state of a DC power source; an electronic adjustable timing loop for generating a clock; an electronic switching circuit for switching to a load or a display state with the use of the timing loop; a plurality of loads for automatically detecting the DC power source; an equivalent load matching to predetermined load conditions and a DC power source state display device; a voltage signal detecting device for processing voltage states; a current signal detecting device for processing current states; and a DC power protection device for protecting a DC power system and other related device. The DC power protection device comprises an over voltage protection device for performing a voltage-protection of the DC power system and other related device; an over current protection device for performing a current-protection of the DC power system and other related device; and an over load protection device for performing a current-protection of the DC power system and other related device.

The various objects and advantages of the present invention will be more readily understood from the following detailed description when read in conjunction with the appended drawing.

### BRIEF DESCRIPTION OF THE DRAWINGS

FIG. 1 is a circuit block diagram of a preferred embodiment of the present invention.

FIG. 2 is a flow diagram of the present invention.

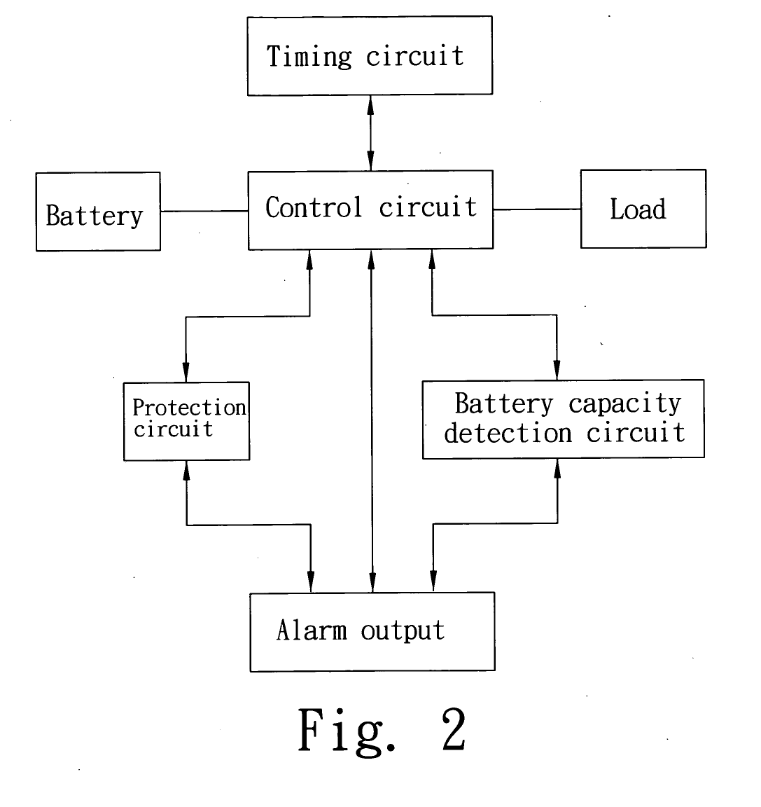

FIG. 3 is a logic flow diagram of the present invention.

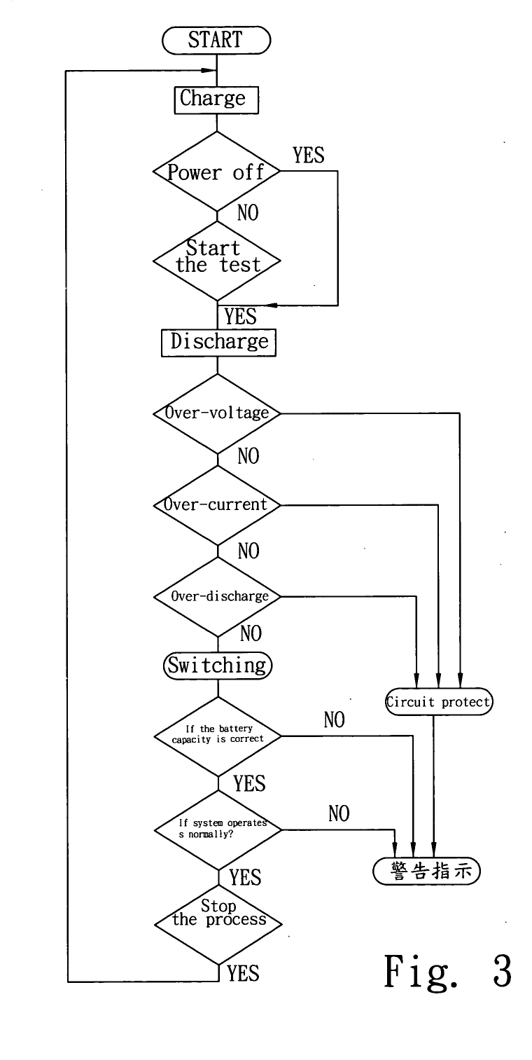

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

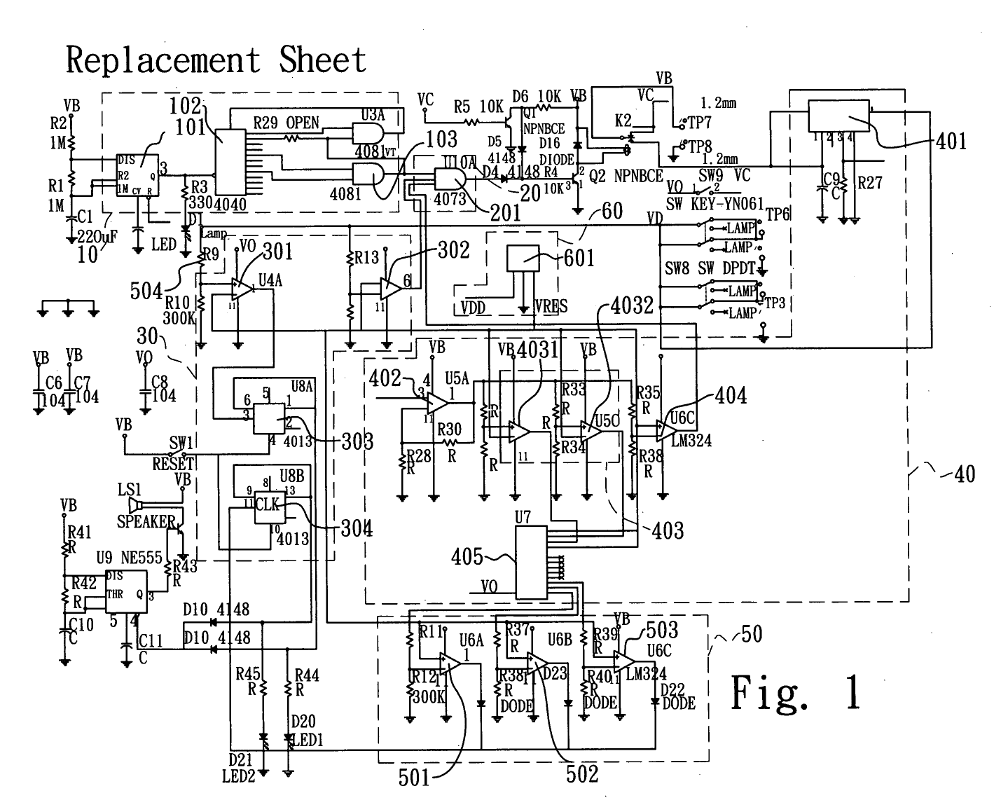

With reference to FIG. 1, a preferred embodiment about the DC battery power detection, display and protection of the present invention is illustrated. As illustrated in the drawing, the present invention includes a timing loop 10 which has a clock generation circuit 101, a timing circuit 102 and an AND logic gate 103.

The connection of the present invention will be described hereinafter. The clock generation circuit 101 generate a base clock. An output end of the clock generation circuit 101 is coupled to an input end of a timing circuit 102. An output end of the timing circuit 102 is an input of the AND logic gate 103. In this design, to have an easy design device, the clock T from the clock generation circuit 101 is used as a base. The timing circuit 102 generates an adjustable testing period T=nT′ for being used to various devices.

Under such as design, when T=nT′, an AND logic gate 201 is used in switching. An input of the AND logic gate 201 is electrically coupled to the outputs of the AND logic gate 103 and an over voltage protection circuit 302 of an over voltage detection and protection circuit 30 and an output of an over current protection circuit 404 of an over current detection and protection circuit 40 so as to form an operation loop. The operation loop receives an input signal from the timing loop 10 through the AND logic gate 103. The loop is conductive for testing.

The over voltage detection and protection circuit 30 includes a voltage detection circuit 301, a voltage protection circuit 301, an over voltage lock circuit 303, and a low voltage lock circuit 304. The voltage detection circuit 301 serves for detecting and comparing load voltages. An input of the voltage detection circuit 301 is coupled to a load connected to a DC power source and a regulating circuit 601 of a reference voltage circuit 60. The voltage protection circuit 302 serves for detecting and protecting DC power source. An input of the voltage protection circuit 302 is coupled to the regulating circuit 601 of a reference voltage circuit 60.

The voltage detection circuit 301 compares the load voltage with a reference voltage Vref. When the comparison value is great than a standard value, a warning signal is transferred to the over voltage lock circuit 303. Then a voltage signal light LED1 is light up. The over voltage lock circuit 303 locks the operation of the system to protect the load and transfers a cut off signal to the AND logic gate 201 of the operation circuit 20. Then the testing procedure is cut off and then enters into a power discharge mode to protect the battery from destroy.

The over voltage protection circuit 302 compares the load voltage with the reference voltage Vref. When the comparison is lower than a standard value, a cut off signal is transferred to the AND logic gate 201 of the operation circuit 20 to cut off the test procedure or enters into a power discharge mode so as to protect the battery from destroy.

The voltage detection circuit 301 is an OP amplifier and the over voltage protection circuit 302 may also be an OP amplifier. However the voltage detection circuit 301 and the over voltage protection circuit 302 may be other differential circuits used for voltage comparison. The cut off circuit 303 (over voltage lock circuit 303) may be a 40131C. The over voltage lock circuit 303 is not only a 40131C, but it may be various latch circuits.

The over current detection and protection circuit 40 includes a current detection circuit 401, a current amplifier 402, and a current comparison circuit 403. The current comparison circuit 403 further includes a first stage current comparison circuit 4031, a second stage current comparison circuit 4032, a current protection circuit 404, and a selection circuit 405. An input of the current detection circuit 401 is coupled to the DC power source. An output thereof is coupled to the input of the current amplifier 402. The input of the current amplifier 402 is coupled to an output of the current detection circuit 401 and an output thereof is coupled to the current comparison circuit 403. An input of the first stage current comparison circuit 4031 of the current comparison circuit 403 is coupled to the output of the current amplifier 402 and the output thereof is coupled to an input of the selection circuit 405. The second stage current comparison circuit 4032 of the current comparison circuit 403 has an input coupled to the output of the current amplifier 402 and has an output coupled to an input control end of the selection circuit 405. An input of the over current protection circuit 404 is coupled to the input of the current amplifier 402. An output of the over current protection circuit 404 is coupled to one end of the AND logic gate 201. An input control end of the selection circuit 405 is coupled to an output of the current comparison circuit 4031. The input control end of the selection circuit 405 is coupled to an output of the second stage current comparison circuit 4032. The input of the selection circuit 405 is connected to a voltage end of the load which is connected to a DC power source. An output of the selection circuit 405 has three outputs based on the signals of the input ends which are coupled to the comparison circuits 501, 502, and 503 which are corresponding to different loads.

The current detection circuit 401 serves to get DC power signals. Current signals are converted to voltage signals through the induction of coils. The conversion ratio is determined by coils of primary side and secondary side. A circuit isolation is achieved by a current and voltage conversion mechanism so as to avoid the interference of the control circuit due to the overload of the power circuit. Meanwhile, the objects of signal conversion and circuit protection are achieved. The current amplifier 402 amplifies the detection signals from the current detection circuit 401 for the signal comparison and classifying of the current comparison circuit 403 and to reduce the output impedance so as to increase the power efficiency. The current comparison circuit 403 has a first stage current comparison circuit 4031 and second stage current comparison circuit 4032 for analyzing current. The current comparison circuit 403 determines the size of a load with the load selection circuit 405 so as to be corresponding to a related comparison path. The load selection circuit 405 is a level-classification circuit for classifying the voltage level from the current comparison circuit 403 and serves to place signals into a load circuit 50.

The current detection circuit 401 may be a Hall sensor. The current detection circuit 401 is not only a Hall sensor, but also may be a conversion circuit used to current and voltage. The current amplifier 402, first stage current comparison circuit 4031, second stage current comparison circuit 4032, and over current protection circuit 404 may be OP amplifiers or differential circuits used in the comparison of voltage. The load selection circuit 405 may be a 4051IC, or other circuit used in current classification. For a 4051IC, current may be classified as following.

1. If current is smaller than 10 Ampere (Am), it is considered that no load is applied.

2. If circuit is between 10 Ampere and 20 Ampere, it is considered as a first class load.

3. If circuit is between 20 Ampere and 30 Ampere, it is considered as a second class load.

4. If circuit is between 30 Ampere and 50 Ampere, it is considered as a third class load.

5. If circuit is over than 50 Ampere, the battery fault light LED2 lights up.

The load circuit 50 includes a first stage load circuit 501, a second stage load circuit 502, and a third stage load circuit 503. Each load has at least one display circuit and at least one load resistor. The load is compared by the selection circuit 405 for determining a corresponding circuit. When a voltage signal corresponding to the load is transferred to a corresponding one of the comparison 501, 502, 503, if the load voltage is lower than the reference voltage, the corresponding comparison sends an alarm signal to the low voltage lock circuit 304 and then the battery fault signal light LED2 light up.

The reference voltage circuit includes a regulating circuit 601 for providing a stable reference voltage Vref. The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An automatic DC power detection device containing circuit protection device for over-voltage and over-current protection; the device comprising:
a DC power detection and display device for detecting a state of a DC power source;
an electronic adjustable timing loop for generating a clock;
an electronic switching circuit for switching to a load or a display state with the use of the timing loop;
a plurality of loads for automatically detecting the DC power source;
an equivalent load matching to predetermined load conditions and a DC power source state display device;
a voltage signal detecting device for processing voltage states;
a current signal detecting device for processing current states; and
a DC power protection device for protecting a DC power system and other related devices; the DC power protection device comprising:
an over voltage protection device for performing a voltage-protection of the DC power system and other related devices;
an over current protection device for performing a current-protection of the DC power system and other related devices; and
an over load protection device for performing a current-protection of the DC power system and other related device.

2. The elevational adjusting device of an exercise bicycle as claimed in claim 1, wherein the DC power source is a battery system.

3. The elevational adjusting device of an exercise bicycle as claimed in claim 1, wherein the DC power is a vehicle-used battery system.

4. The elevational adjusting device of an exercise bicycle as claimed in claim 1, wherein the load is a passive load system.

5. The elevational adjusting device of an exercise bicycle as claimed in claim 2, wherein the load is a passive load system.

6. The elevational adjusting device of an exercise bicycle as claimed in claim 3, wherein the load is a passive load system.
